(19) United States
(12) Patent Application Publication
(10) Pub. No.: US 2023/0294771 A1
(43) Pub. Date: Sep. 21, 2023

(54) VEHICLE BODY SIDE STRUCTURE

(71) Applicant: HONDA MOTOR CO., LTD., Tokyo (JP)

(72) Inventor: Kenji INAGAKI, Tokyo (JP)

(21) Appl. No.: 18/173,166

(22) Filed: Feb. 23, 2023

(30) Foreign Application Priority Data
Mar. 18, 2022 (JP) 2022-044429

(51) Int. Cl. B62D 21/15; B62D 21/09; B62D 21/08

(52) U.S. Cl. CPC B62D 21/157; B62D 21/09; B62D 21/08

(57) ABSTRACT

A vehicle body side structure of the present invention includes: a floor cross member that is connected to a side sill and that extends in a vehicle width direction; and a bulk head that partitions a closed cross section of the side sill in a vehicle body front-rear direction, at the side of the floor cross member in the vehicle width direction. The bulk head includes a partition wall that partitions the closed cross section in the vehicle body front-rear direction and a flange that extends from an edge portion of the partition wall in both of a vehicle body front direction and a vehicle body rear direction and that is formed over an entire periphery of the edge portion of the partition wall. The flange is connected to the floor cross member with the side sill in between.

### BACKGROUND OF THE INVENTION

### 1. Field of the Invention

The present invention relates to a vehicle body side structure.

### 2. Description of the Related Art

In recent years, research and development for weight reduction that contributes to an increase in energy efficiency are conducted to allow more people to secure access to affordable, reliable, sustainable, advanced energy.

As a vehicle body side structure, there has been conventionally known a structure that includes a side member, a cross member, and a side sill inner panel (for example, see Patent Literature 1). Specifically, in this structure, paired bulk heads are attached parallel to each other at a position on a left-right extended line of a cross rear wall of the cross member with a side inner wall of the side member in between and at a position behind this position.

According to the vehicle body side structure as described above, load in side impact is efficiently transmitted from the side sill inner panel to the cross member. In the vehicle body side structure, load is thus not concentrated in a certain portion among the members, and the stiffness of the vehicle body is increased.

### PRIOR ART DOCUMENT(S)

### Patent Literature(s)

Patent Literature 1: JP2004-306777A

### SUMMARY OF THE INVENTION

The paired bulk heads in the conventional vehicle body side structure (for example, see Patent Literature 1) are each configured to include a partition wall and a flange that extends only forward or rearward from the partition wall. Moreover, these bulk heads are joined to an outer surface of the side inner wall, an upper surface of a side lower wall, and an inner surface of a sill inner vertical wall, in the flanges.

Meanwhile, there is a demand for reduction of the paired bulk heads to one bulk head to reduce the weight of the vehicle body. However, the bulk heads in the conventional vehicle body side structure have a limited number of joining points provided by the flanges, and sufficient joining strength is difficult to secure. Accordingly, the conventional vehicle body side structure has a problem of not being able to achieve both of an increase in energy efficiency by weight reduction of the vehicle body and an improvement in traffic safety by securing of the stiffness of the vehicle body.

Thus, an object of the present invention is to provide a vehicle body side structure that achieves both of the increase in energy efficiency by weight reduction of the vehicle body and the improvement in traffic safety by securing of the stiffness of the vehicle body.

A vehicle body side structure of the present invention to achieve the above object is a vehicle body side structure including: a side sill that extends in a vehicle body front-rear direction in a vehicle body side portion and that forms a closed cross section; a floor cross member that is connected to the side sill and that extends in a vehicle width direction; and a bulk head that partitions the closed cross section of the side sill in the vehicle body front-rear direction, at the side of the floor cross member in the vehicle width direction, in which the bulk head includes a partition wall that partitions the closed cross section, and a flange that extends from an edge portion of the partition wall in both of a vehicle body front direction and a vehicle body rear direction and that is formed over an entire periphery of the edge portion of the partition wall, and the flange is connected to the floor cross member with the side sill in between.

The present invention can provide a vehicle body side structure that achieves both of an increase in energy efficiency by weight reduction of the vehicle body and an improvement in traffic safety by securing of the stiffness of the vehicle body.

### BRIEF DESCRIPTION OF THE DRAWINGS

FIG. 1 is a partial enlarged perspective view in which a vehicle body including a vehicle body side structure according to an embodiment of the present invention is overlooked obliquely from a position that is above and on the left side of the vehicle.

FIG. 2 is a partially enlarged perspective view in which the A portion shown in FIG. 1 is overlooked obliquely from a position above and on the front left side of the A portion.

FIG. 3 is a partially enlarged perspective view in which the A portion shown in FIG. 1 is viewed obliquely from a position front of and on the vehicle inner side of the A portion.

FIG. 4A is a partially enlarged perspective view in which a bulk head forming the vehicle body side structure according to the embodiment of the present invention is overlooked obliquely from a position above and on the front left side of the bulk head.

FIG. 4B is a partially enlarged perspective view in which the bulk head forming the vehicle body side structure according to the embodiment of the present invention is overlooked obliquely from a position above and on the rear left side of the bulk head.

FIG. 4C is an exploded view of the bulk head forming the vehicle body side structure according to the embodiment of the present invention.

FIG. 5A is a side view of the bulk head in the case where a side sill outer and a side sill outer rear member are removed in the vehicle body side structure of FIG. 1.

FIG. 5B is a cross-sectional view along the line Vb-Vb of FIG. 5A.

FIG. 5C is a perspective view showing a joining mode of a bulk head rear portion to a side sill inner.

FIG. 5D is a perspective view showing a joining mode of a bulk head front portion to the side sill inner.

FIG. 5E is a perspective view showing a joining mode of the bulk head to the side sill outer.

### DETAILED DESCRIPTION OF THE EMBODIMENTS

Next, a mode (embodiment) of carrying out a vehicle body side structure of the present invention is described in detail with reference to the drawings as appropriate. Note that directions indicated by front, rear, upper, lower, left, and right arrows in the referred drawings match front, rear, upper, lower, left, and right directions of a vehicle body. Moreover, in the following description, a vehicle width direction is sometimes referred to as left-right direction of the vehicle body.

In the vehicle body side structure of the present embodiment, flanges of a bulk head arranged in a closed cross section (hollow portion) of a side sill extend from an edge portion of a partition wall of the bulk head in both of vehicle body front and rear directions, and are formed continuously over the entire periphery of the edge portion of the partition wall. Moreover, this vehicle body side structure is mainly characterized in that the bulk head is connected to a floor cross member via the flanges with the side sill arranged between the bulk head and the floor cross member.

Although the vehicle body side structure of the present embodiment is arranged in each of left and right portions of the vehicle body to correspond to the side sill arranged in each of the left and right portions of the vehicle body, these structures have structures that are left-right symmetric to each other. Accordingly, only the left vehicle body side structure is described in the present embodiment, and detailed description of the right vehicle body side structure is omitted.

An overall configuration of the vehicle body including the vehicle body side structure is first described below, and then the vehicle body side structure is described in detail.

### <<Overall Configuration of Vehicle Body>>

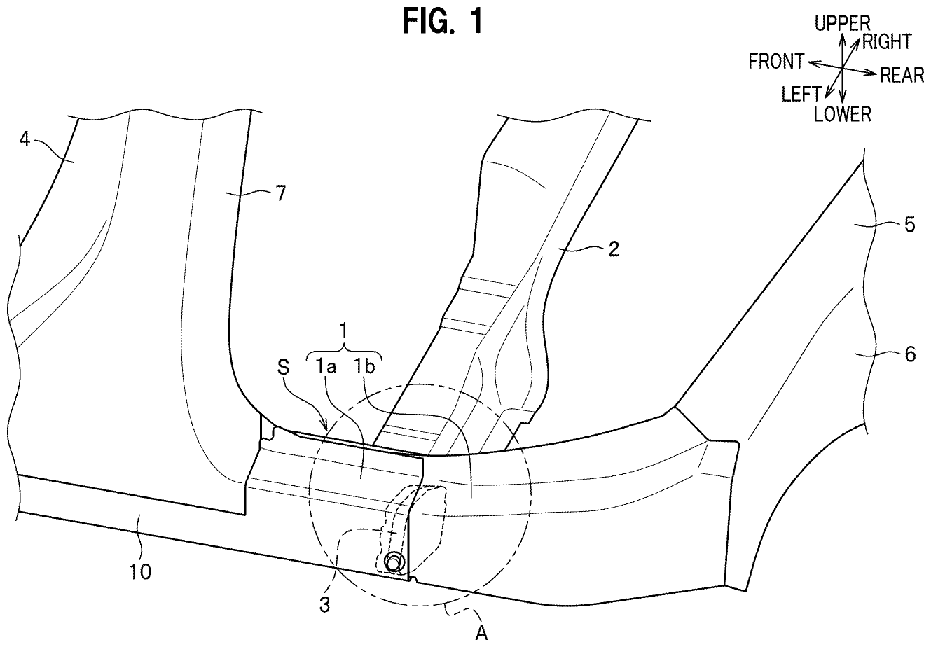

FIG. 1 is a partial enlarged perspective view of a vehicle body 10 including a vehicle body side structure S according to the present embodiment.

As shown in FIG. 1, the vehicle body 10 includes a side sill 1, a floor cross member 2, and a bulk head 3 arranged in a closed cross section (hollow portion) of the side sill 1. Note that the bulk head 3 is shown by hidden lines (dotted lines) in FIG. 1.

The side sill 1 is an elongated member that extends along a vehicle body front-rear direction, on the vehicle width direction outer side of a vehicle body lower portion, as specifically described later.

A front pillar (not shown) extends upward from a front end portion (not shown) of the side sill 1. Moreover, a center pillar 4 extends upward in a center portion of the side sill 1 in the vehicle body front-rear direction. Furthermore, a rear wheel house 6 formed of a portion of a rear side panel 5 is connected to a rear end portion of the side sill 1. Note that, although not shown, a quarter pillar is arranged to extend upward, above the rear wheel house 6.

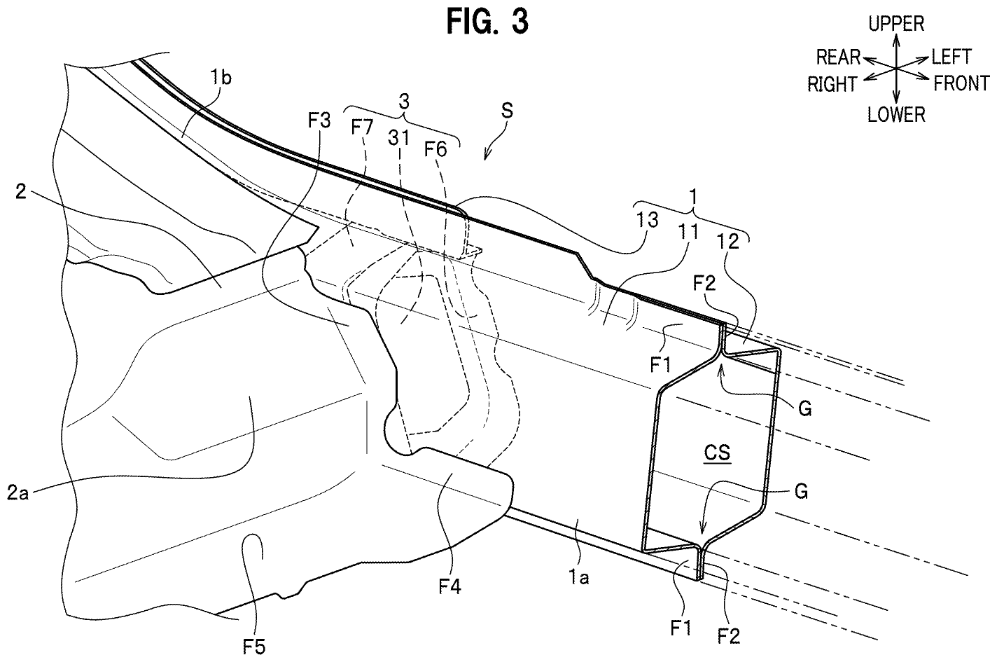

The floor cross member 2 extends in the vehicle width direction between a connection portion of the center pillar 4 to the side sill 1 and a connection portion of the rear wheel house 6 to the side sill 1. An end portion of the floor cross member 2 in the vehicle width direction is connected to a side sill inner 11 (see FIG. 3) forming the side sill 1 as described later.

Moreover, although not shown, an upper end portion of the quarter pillar, an upper end portion of the front pillar, and an upper end portion of the center pillar 4 are connected to a roof side rail that extends along the vehicle body front-rear direction, on the vehicle width direction outer side of a vehicle body upper portion.

An opening portion 7 for a rear door (not shown) of the vehicle body 10 is formed in a vehicle body side portion by being surrounded by the center pillar 4, the side sill 1, a front portion of the rear wheel house 6, the quarter pillar (not shown), and the roof side rail (not shown).

Note that, although not shown, the vehicle body side structure S in the present embodiment is assumed to be a structure including a side panel outer that forms a design surface on the vehicle outer side by covering the center pillar 4, the side sill 1, the roof side rail (not shown), and the rear side panel 5 integrally forming the rear wheel house 6 and the quarter pillar (not shown), from the vehicle width direction outer side.

### <<Vehicle Body Side Structure>>

Next, the vehicle body side structure S (see FIG. 1) of the present embodiment is described.

The vehicle body side structure S of the present embodiment is configured to mainly include the side sill 1, the floor cross member 2, and the bulk head 3.

### <Side Sill>

As shown in FIG. 1, the side sill 1 forming the vehicle body side structure S is configured to include a general portion 1a of the side sill 1 that extends forward beyond a connection portion with the floor cross member 2 and a rear end portion 1b that extends toward the rear wheel house 6 side behind the general portion 1a.

The general portion 1a extends in the vehicle body front-rear direction such that the upper-lower width of the side sill 1 is substantially uniform in a vehicle body side view. Meanwhile, in the rear end portion 1b of the side sill 1, an upper edge thereof is tilted to be gradually shifted upward while extending rearward in the vehicle body side view. The rear side of the rear end portion 1b connected to the rear wheel house 6 is such that an upper surface of the rear end portion 1b is smoothly joined to the rear wheel house 6 in accordance with a curvature of the rear wheel house 6.

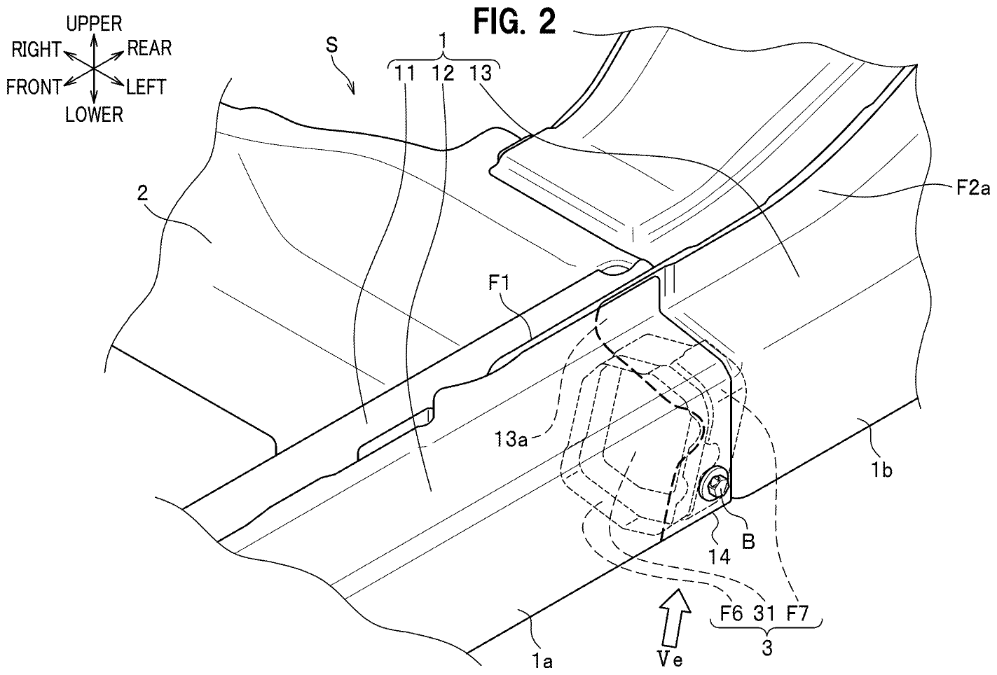

FIG. 2 is a partially enlarged perspective view in which the A portion shown in FIG. 1 is overlooked obliquely from a position above and on the front left side of the A portion. FIG. 3 is a partially enlarged perspective view in which the A portion shown in FIG. 1 is viewed obliquely from a position front of and on the vehicle inner side of the A portion.

As shown in FIG. 2, the side sill 1 forming the vehicle body side structure S of the present embodiment includes the side sill inner 11, a side sill outer 12, and a side sill outer rear member 13.

As shown in FIG. 2, the side sill inner 11 extends in the vehicle body front-rear direction to form an inner half body of the side sill 1 in the vehicle width direction.

The side sill outer 12 is arranged to extend in the vehicle body front-rear direction in a vehicle width direction outer portion of the side sill 1. Specifically, the side sill outer 12 is arranged on the vehicle width direction outer side of the side sill inner 11 in a region corresponding to the general portion 1a of the side sill 1.

The side sill outer rear member 13 is arranged on the vehicle width direction outer side of the side sill inner 11 in a region corresponding to the rear end portion 1b of the side sill 1.

Note that the side sill outer 12 and the side sill outer rear member 13 are joined to each other in an overlapping portion 14 in which a rear end portion of the side sill outer 12 overlaps a front end portion of the side sill outer rear member 13, on the vehicle width direction outer side of the front end portion. Note that, in FIG. 2, a front edge 13a of the side sill outer rear member 13 is shown by a hidden line (dotted line).

As shown in FIG. 3, a cross-sectional shape of the side sill inner 11 orthogonal to the longitudinal direction is a hat shape opened on the vehicle width direction outer side in a portion corresponding to the general portion 1a of the side sill 1. Specifically, in the side sill inner 11, a portion corresponding to a crown portion of the hat shape has a substantially isosceles trapezoid shape, and the side sill inner 11 has paired upper and lower flanges F1 and F1 corresponding to a brim portion of the hat shape.

Moreover, a cross-sectional shape of the side sill outer 12 orthogonal to the longitudinal direction is a hat shape opened on the vehicle width direction inner side. Specifically, in the side sill outer 12, a portion corresponding to a crown portion of the hat shape has a substantially isosceles trapezoid shape that is left-right symmetric to the side sill inner 11, and the side sill outer 12 has paired upper and lower flanges F2 and F2 corresponding to a brim portion of the hat shape.

The flanges F1 and F1 of the side sill inner 11 and the flanges F2 and F2 of the side sill outer 12 are joined to one another by spot welding or the like, and a substantially hexagonal closed cross section CS is thereby formed in a portion corresponding to the crown portions of the side sill inner 11 and the side sill outer 12 in the general portion 1a of the side sill 1.

Moreover, although not shown, each of the side sill inner 11 and the side sill outer rear member 13 in a portion corresponding to the rear end portion 1b of the side sill 1 is formed such that the upper-lower width of the crown portion of the hat shape gradually increases depending on the tilt of the rear end portion 1b of the side sill 1.

As shown in FIG. 2, the flanges F1 of the side sill inner 11 and flanges F2a of the side sill outer rear member 13 in the portion corresponding to the rear end portion 1b of the side sill 1 are joined to one another by spot welding or the like. The rear end portion 1b of the side sill 1 thereby has a closed cross section (hollow portion) in which the upper-lower width of a space gradually increases while the space extends rearward. The rear end portion 1b of the side sill 1 as described above is connected to the front portion of the rear wheel house 6 (see FIG. 1) as described above. Although the steel rear wheel house 6 (see FIG. 1) and the steel side sill 1 are assumed to be subjected to similar material joining in the present embodiment, the configuration is not limited to this.

### <Floor Cross Member>

Next, the floor cross member 2 (see FIG. 1) forming the vehicle body side structure S is described.

Although not shown, the floor cross member 2 in the present embodiment has a substantially-hat shape opened on the lower side in a cross-sectional view orthogonal to the vehicle width direction. The floor cross member 2 is joined to an upper surface of a floor panel (not shown) by spot welding or the like, in flanges formed to correspond to a brim portion of the substantially-hat shape.

Although not shown, the floor panel in the present embodiment is assumed to be a floor panel including a floor tunnel extending in the front-rear direction and partially rising at the vehicle width direction center.

As shown in FIG. 1, in a vehicle width direction center portion of the floor cross member 2, an upward bulge is thus partially formed to match a shape of the floor tunnel.

As shown in FIG. 2, the floor cross member 2 extends in the vehicle width direction at a position corresponding to the overlapping portion 14 of the side sill outer 12 and the side sill outer rear member 13.

Moreover, as shown in FIG. 3, the floor cross member 2 includes a flange F3 and a flange F4 in an end portion on the vehicle width direction outer side.

As shown in FIG. 3, the flange F3 extends from a vehicle width direction outer side end edge of a front side wall 2a of the floor cross member 2, along a vehicle width direction inner surface of the side sill inner 11. Moreover, the flange F4 extends from a vehicle width direction outer side end edge of a flange F5, along the vehicle width direction inner surface of the side sill inner 11, the flange F5 corresponding to the brim portion of the substantially-hat shaped floor cross member 2.

The floor cross member 2 is connected to the side sill 1 at the flanges F3 and F4.

Note that the flanges F3 and F4 and the side sill inner 11 in the present embodiment are assumed to be joined by spot welding.

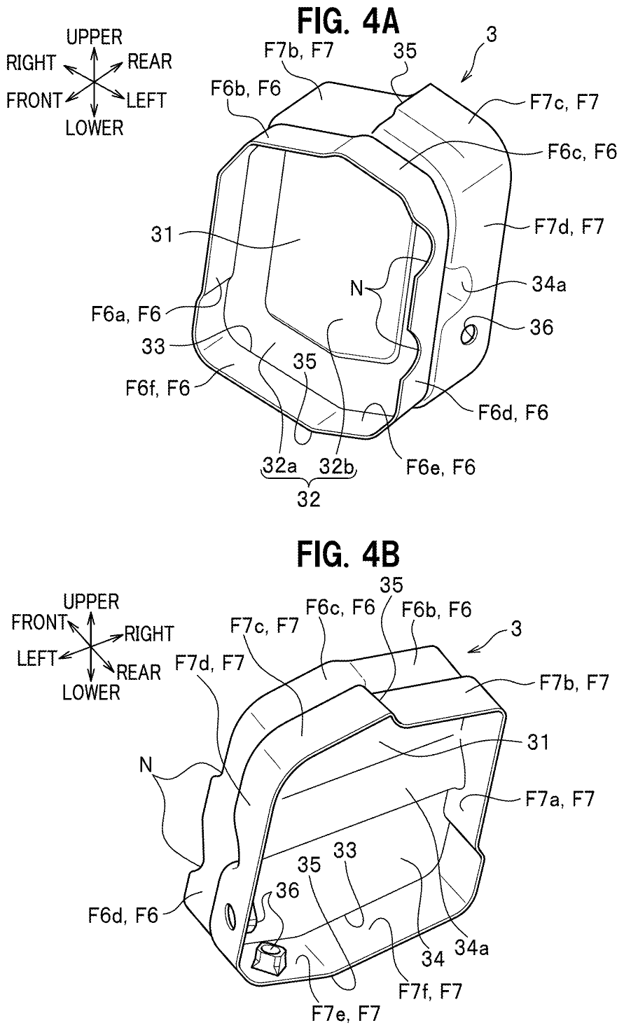

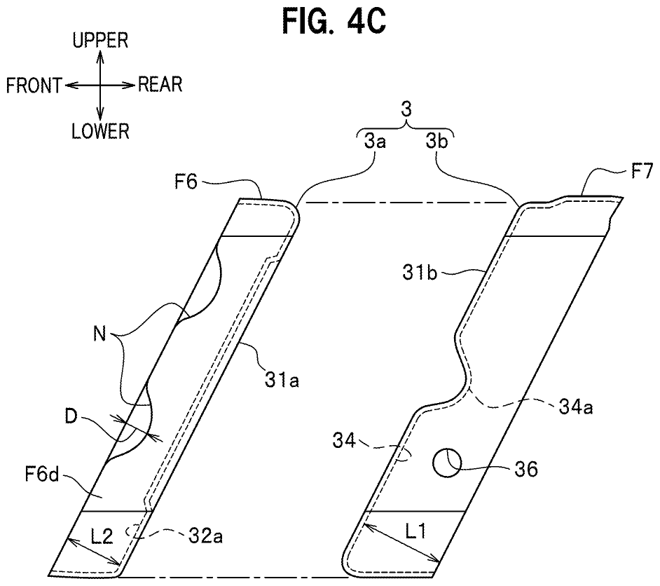

The flange F3 of the floor cross member 2, the side sill inner 11, and a flange F6a (see FIG. 4A) of the bulk head 3 to be described next are joined to one another while being made to overlap one another in three layers.

### <Bulk Head>

As shown in FIGS. 1 to 3, the bulk head 3 is arranged in the closed cross section (hollow portion) of the side sill 1.

Specifically, as shown in FIG. 2, the bulk head 3 is arranged at the position corresponding to the overlapping portion 14 of the side sill outer 12 and the side sill outer rear member 13, and partitions the hollow portion of the side sill 1 in the front-rear direction.

FIG. 4A is a partially enlarged perspective view in which the bulk head 3 is overlooked obliquely from a position above and on the front left side of the bulk head 3. FIG. 4B is a partially enlarged perspective view in which the bulk head 3 is overlooked obliquely from a position above and on the rear left side of the bulk head 3. FIG. 4C is an exploded view of the bulk head.

Note that the directions of front, rear, upper-lower, left, and right in the bulk head 3 shown in FIGS. 4A to 4C match the directions of front, rear, upper-lower, left, and right in FIGS. 1 to 3.

As shown in FIGS. 4A and 4B, the bulk head 3 is configured to mainly include a partition wall 31 and flanges F6 and F7. Note that the flange F6 corresponds to a “front flange” described in the scope of claims, and the flange F7 corresponds to a “rear flange” described in the scope of claims.

The partition wall 31 is formed of a plate shaped member that partitions the hollow portion of the side sill 1 in the front-rear direction.

As shown in FIG. 4A, a base plate surface portion 32a and a bulging portion 32b are formed on a front surface 32 of the partition wall 31. The base plate surface portion 32a constitutes an outer peripheral portion of the front surface 32 of the partition wall 31, and forms an edge portion 33 of the partition wall 31 in which the flanges F6 and F7 stand upright.

The bulging portion 32b is formed to bulge forward in a plateau shape beyond the base plate surface portion 32a, in a center portion of the front surface 32 of the partition wall 31.

As shown in FIG. 4B, a bead 34a is formed on a rear surface 34 of the partition wall 31.

The bead 34a is formed as a protruding strip portion that partially protrudes rearward from the rear surface 34. The bead 34a extends in the left-right direction at substantially the center of the rear surface 34 of the partition wall 31 in the upper-lower direction. Specifically, the bead 34a extends to lead from a portion of the flange F7 located on the vehicle width direction outer side to a portion of the flange F7 located on the vehicle width direction inner side. More specifically, the bead 34a extends to connect a flange F7a and a flange F7c in the flange F7.

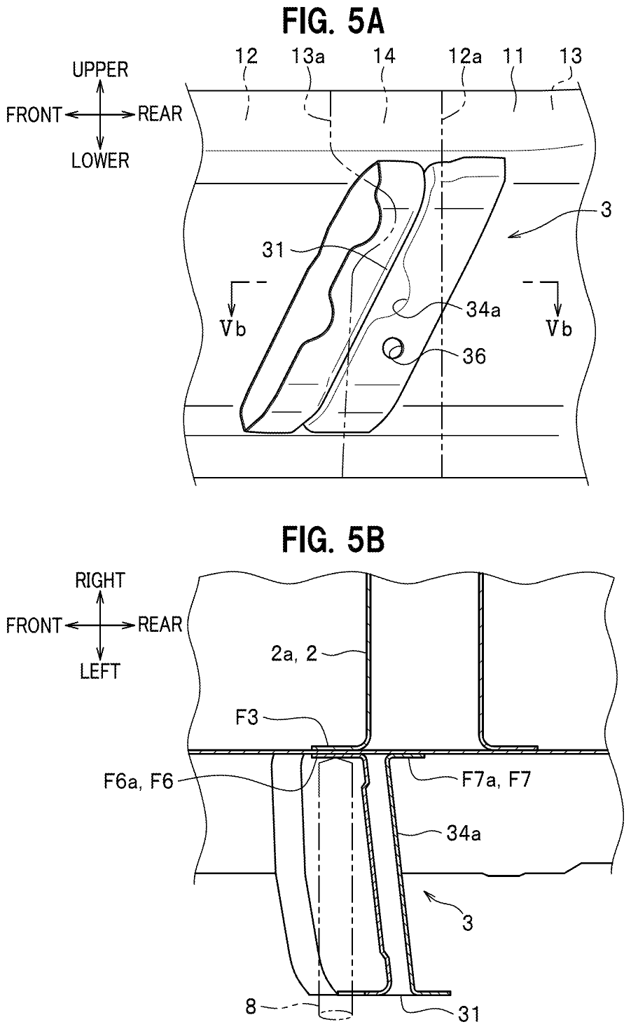

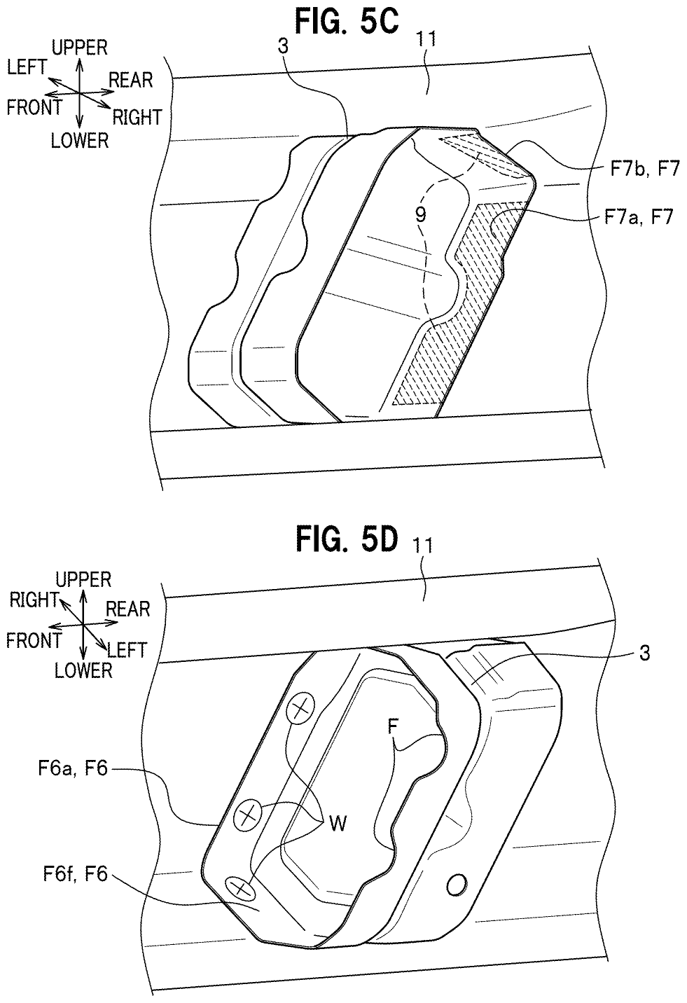

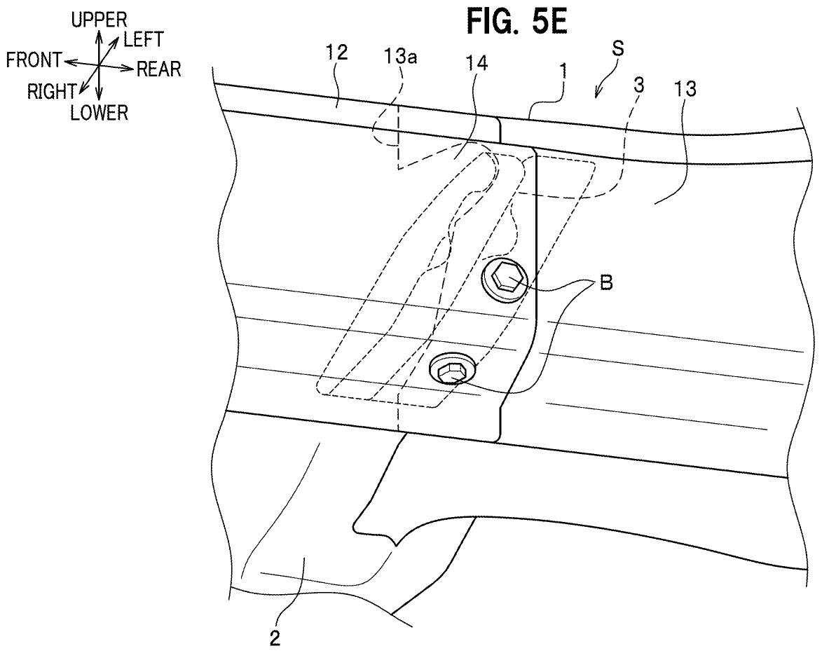

The partition wall 31 in the present embodiment as described above is arranged to be tilted in the hollow portion of the side sill 1 (see FIG. 2) as described in detail later (see FIGS. 5A and 5B).

Moreover, the bead 34a of the partition wall 31 extends in the vehicle width direction (left-right direction) at a position overlapping and on the vehicle width direction outer side of the floor cross member 2 (see FIG. 5B) as described in detail later.

Next, the flange F6 (front flange) and the flange F7 (rear flange) are described.

As shown in FIGS. 4A and 4B, the flanges F6 and F7 are formed over the entire periphery of the edge portion 33 of the partition wall 31.

The flange F6 is formed to stand upright from the edge portion 33 (peripheral edge portion) of the partition wall 31 toward the front side. Moreover, the flange F7 is formed to stand upright from the edge portion 33 (peripheral edge portion) of the partition wall 31 toward the rear side.

Specifically, the flange F6 and the flange F7 extend from the partition wall 31 in both of the vehicle body front direction and the vehicle body rear direction, respectively.

As described above, the flanges F6 and F7 formed continuously over the entire periphery of the partition wall 31 form a tubular body extending in the front-rear direction with the partition wall 31 sandwiched between the flanges F6 and F7.

A peripheral surface of the tubular body formed by the flange F6 and the flange F7 extends along an inner peripheral surface of the hollow portion of the side sill 1 (see FIG. 2) when the partition wall 31 of the bulk head 3 is arranged to be tilted in the hollow portion of the side sill 1.

Specifically, in the flange F6 formed over the entire periphery of the partition wall 31, the right flange F6a and a flange F6b and a flange F6f arranged such that the flange F6a is vertically sandwiched therebetween are arranged to extend along an inner peripheral surface of the side sill inner 11 (see FIG. 3).

Moreover, in the flange F6, a left flange F6d and a flange F6c and a flange F6e arranged such that the flange F6b is vertically sandwiched therebetween are arranged to extend along an inner peripheral surface of the overlapping portion 14 (see FIG. 2) of the side sill outer 12 (see FIG. 2) and the side sill outer rear member 13 (see FIG. 2).

Note that the flange F6a among the flanges F6a to the flange F6f forming the flange F6 as described above corresponds to an “inner flange” described in the scope of claims, and the flange F6d corresponds to an “outer flange” described in the scope of claims.

Moreover, in the flange F7 formed over the entire periphery of the partition wall 31, the right flange F7a and a flange F7b and a flange F7f arranged such that the flange F7a is sandwiched therebetween are arranged to extend along the inner surface of the side sill inner 11 (see FIG. 3).

Furthermore, in the flange F7, a left flange F7d and the flange F7c and a flange F7e arranged such that the flange F7d is vertically sandwiched therebetween are arranged to extend along the inner peripheral surface of the overlapping portion 14 (see FIG. 2) of the side sill outer 12 (see FIG. 2) and the side sill outer rear member 13 (see FIG. 2).

Moreover, paired upper and lower ridge portions 35 are formed on a peripheral surface of the tubular body formed of the flange F6 and the flange F7. These ridge portions 35 are portions formed in a strip shape extending in the front-rear direction by causing the peripheral surface of the tubular body formed of the flange F6 and the flange F7 to partially protrude toward the outer peripheral side.

The ridge portions 35 as described above are configured to be fitted to groove portions G (see FIG. 3) formed in seams between the side sill inner 11 (see FIG. 3) and the side sill outer 12 (see FIG. 3) when the bulk head 3 is arranged in the hollow portion of the side sill 1 (see FIG. 3).

The groove portions G are grooves formed based on a radius R of bending from the crown portion to the brim portion of the hat shape in each of the side sill inner 11 and the side sill outer 12.

Note that reference sign 36 in FIGS. 4A and 4B denotes female thread portions for fastening the bulk head 3 to the overlapping portion 14 of the side sill outer 12 and the side sill outer rear member 13 with bolts B as shown in FIG. 2. The female thread portions 36 are provided in a lower portion of the flange F7d shown in FIG. 4A and in a left end portion of the flange F7e shown in FIG. 4B.

Moreover, reference sign N denotes arc shaped notches formed in the flange F6d. The notches N are provided at multiple locations (two locations in the present embodiment) to correspond to welding spots W (see FIG. 5A) of spot welding of the flange F6a to be described later.

The bulk head 3 in the present embodiment as described above can be obtained by joining a bulk head front portion 3a that is a front half body of the bulk head 3 and a bulk head rear portion 3b that is a rear half body as shown in FIG. 4C.

As shown in FIG. 4C, the bulk head front portion 3a includes a front partition wall half body 31a and the flange F6 (front flange) extending forward from an edge portion of the front partition wall half body 31a.

Note that the front partition wall half body 31a corresponds to a “partition wall front portion” described in the scope of claims.

Moreover, the bulk head rear portion 3b includes a rear partition wall half body 31b and the flange F7 (rear flange) extending rearward from an edge portion of the rear partition wall half body 31b.

Note that the rear partition wall half body 31b corresponds to a “partition wall rear portion” described in the scope of claims.

As shown in FIG. 4C, the length L1 of the flange F7 (rear flange) from the rear surface 34 of the rear partition wall half body 31b is larger than the length L2 of the flange F6 (front flange) from the base plate surface portion 32a of the front partition wall half body 31a. Note that the length L1 corresponds to the “length of the rear flange from the partition wall” described in the scope of claims, and the length L2 corresponds to the “length of the front flange from the partition wall” described in the scope of claims.

Moreover, the depth D of the notches N in the flange F6 (flange F6d) is set to be half or less of the length L2 of the flange F6 (flange F6d). Note that the flange F6d corresponds to the “outer flange” described in the scope of claims as described above.

Although the bulk head front portion 3a and the bulk head rear portion 3b as described above are assumed to be press-molded products of steel plates, the configuration is not limited to this.

As shown in FIG. 4C, the partition wall 31 (see FIGS. 4A and 4B) of the bulk head 3 is formed by integrally joining the front partition wall half body 31a and the rear partition wall half body 31b such that the bulk head front portion 3a and the bulk head rear portion 3b are arranged back-to-back. Although spot welding, laser welding, and the like can be given as examples of a joining method of the front partition wall half body 31a and the rear partition wall half body 31b, the joining method is not limited to these methods.

### <<Method of Attaching Bulk Head>>

Next, a method of attaching the bulk head 3 (see FIG. 2) to the side sill 1 (see FIG. 2) is described.

FIG. 5A is an explanatory view of an attachment step of the bulk head 3, and is a view showing a state of the bulk head 3 arranged at a predetermined position in the side sill inner 11. FIG. 5B is a cross-sectional view along the line Vb-Vb of FIG. 5A. FIG. 5C is a perspective view showing a joining mode of the bulk head rear portion 3b to the side sill inner 11. FIG. 5D is a perspective view showing a joining mode of the bulk head front portion 3a to the side sill inner 11. FIG. 5E is a perspective view showing a joining mode of the bulk head 3 and the side sill outer 12, and is a view showing a state in which the side sill 1 is viewed upward in the Ve direction in FIG. 2.

In FIG. 5A, reference sign 12a denotes a rear edge of the side sill outer 12 shown by an imaginary line (two-dot chain line). In FIGS. 5A and 5E, reference sign 13a denotes a front edge of the side sill outer rear member 13 shown by imaginary lines (two-dot chain lines). Reference sign 14 denotes the overlapping portion of the side sill outer 12 and the side sill outer rear member 13. In FIG. 5B, reference sign 8 denotes a welding gun for spot welding shown by imaginary lines (two-dot chain lines).

In the attachment step of the bulk head 3 in the present embodiment, as shown in FIGS. 5A and 5B, first, the bulk head 3 is arranged on the vehicle width direction outer side (side closer to the viewer on the sheet surface of FIG. 5A) of the side sill inner 11 in a state where the side sill outer 12 and the side sill outer rear member 13 are not attached to the side sill inner 11.

In this case, as shown in FIGS. 5A and 5B, the bulk head 3 is arranged such that a plate surface of the partition wall 31 of the bulk head 3 is tilted with respect to the front-rear direction and the upper-lower direction.

Specifically, as shown in FIG. 5A, the plate surface of the partition wall 31 is tilted to be gradually shifted rearward while extending upward at the position corresponding to the overlapping portion 14 of the side sill outer 12 and the side sill outer rear member 13.

The bulk head 3 is thereby arranged to extend across the side sill outer rear member 13 and the side sill outer 12 via the overlapping portion 14 in the vehicle body side view.

Moreover, as shown in FIG. 5B, the plate surface of the partition wall 31 is tilted to be gradually shifted rearward while extending toward the vehicle width direction outer side (left side in FIG. 5B).

Specifically, the bulk head 3 is arranged such that the flange F6a of the bulk head 3 corresponds to the flange F3 of the floor cross member 2. The bead 34a formed in the partition wall 31 of the bulk head 3 is thereby arranged to correspond to the front side wall 2a of the aforementioned crown portion of the floor cross member 2 in which the flange F3 is formed.

The tilting of the bulk head 3 as described above avoids interface between the welding gun 8 and the bulk head 3 when the flange F6a is spot-welded to the side sill inner 11 at the welding spots W (see FIG. 5D) to be described later.

A tilt angle of the partition wall 31 as described above with respect to the side sill inner 11 is determined in advance based on a tilt angle of the flanges F6 and F7 with respect to the partition wall 31, the flanges F6 and F7 extending in the tubular shape in the front-rear direction with the partition wall 31 sandwiched therebetween.

In this attachment method, as shown in FIG. 5C, the flange F7 is joined to the side sill inner 11 with structural adhesive 9 when the bulk head 3 is arranged at the predetermined position in the side sill inner 11 described above. Specifically, the flanges F7a, F7b, and F7f (see FIGS. 4A and 4B) in the flange F7 and the side sill inner 11 are joined to one another.

Publicly-known adhesive with high toughness and high viscosity can be used as the structural adhesive 9 in the present embodiment, and examples of the structural adhesive 9 include, but not limited to, epoxy-based resin, 2-hydroxypropyl acrylate (HPA), and the like.

Next, in the attachment method, as shown in FIG. 5D, the flange F6 is spot welded to the side sill inner 11 at the multiple welding spots W. Specifically, the flange F6a in the flange F6 is subjected to spot welding at two locations at upper and lower height levels corresponding to the notches N at two locations in the flange F6d.

The flange F6a of the bulk head 3, the side sill inner 11, and the flange F3 (see FIG. 5D) of the floor cross member 2 (see FIG. 5D) are thereby integrally welded while being made to overlap one another in three layers.

Moreover, although not shown, the flanges F6b and F6f (see FIGS. 4A and 4B) are also spot-welded to the side sill inner 11.

Then, as shown in FIG. 2, the flanges F1 of the side sill inner 11 and the flanges F2a of the side sill outer rear member 13 are joined to one another by spot welding or the like, and the rear end portion 1b of the side sill 1 is formed.

Thereafter, as shown in FIG. 3, the flanges F1 of the side sill inner 11 and the flanges F2 of the side sill outer 12 are joined to one another by spot welding or the like. The general portion 1a of the side sill 1 extending in the vehicle body front-rear direction is thereby formed.

Next, as shown in FIG. 5E, in a side surface lower portion of the side sill 1 on the vehicle width direction outer side (left side in FIG. 5E) and in a portion of a lower surface of the side sill 1 close to the vehicle width direction outer side, paired bolts B are inserted at positions corresponding to the overlapping portion 14 of the side sill outer 12 and the side sill outer rear member 13. These bolts B are screwed to the female thread portions 36 (see FIG. 4B) at the two locations in the bulk head 3. The bulk head 3 is fastened to the overlapping portion 14 of the side sill outer 12 and the side sill outer rear member 13, with these bolts B.

The series of attachment steps of the bulk head 3 to the side sill 1 is thereby completed, and the vehicle body side structure S of the present embodiment is completed.

### <<Actions and Effects>>

Actions and effects provided by the vehicle body side structure S according to the present embodiment are described below.

The bulk head 3 of the vehicle body side structure S according to the present embodiment includes the flanges F6 and F7 that are arranged in the hollow portion of the side sill 1 and that extend from the edge portion 33 of the partition wall 31 in the bulk head 3 in both of the vehicle body front direction and the vehicle body rear direction. The flanges F6 and F7 are each formed to be continuous over the entire periphery of the edge portion 33 of the partition wall 31.

The bulk head 3 as described above has a substantially-H shaped cross section due to the flanges F6 and F7 extending from the partition wall 31 in both of the front and rear directions. The flanges F6 and F7 can provide joining points with the side sill 1 for the bulk head 3, on both of the front and rear sides of the partition wall 31. The joining strength of the bulk head 3 to the side sill 1 is thereby improved.

In the vehicle body side structure S of the present embodiment, it is possible to improve the joining strength of the bulk head 3 to the side sill 1 and thereby reduce the number of the bulk heads, unlike in the conventional vehicle body side structure (for example, see Patent Literature 1) that includes multiple bulk heads. The vehicle body side structure S as described above can achieve an increase in energy efficiency by weight reduction of the vehicle body.

Moreover, in the vehicle body side structure S, the flange F6a of the bulk head 3 is connected to the floor cross member 2 with the side sill 1 in between. The vehicle body side structure S can thereby efficiently transmit side impact load from the side sill 1 to the floor cross member 2.

The vehicle body side structure S as described above can increase the stiffness of the vehicle body while avoiding concentration of the side impact load in a certain portion among the members in side impact. The vehicle body side structure S can thereby achieve both of the increase in energy efficiency by weight reduction of the vehicle body and an improvement in traffic safety by securing of the stiffness of the vehicle body.

Moreover, in the vehicle body side structure S, the partition wall 31 of the bulk head 3 is formed by connecting the front partition wall half body 31a (partition wall front portion) of the bulk head front portion 3a including the flange F6 (front flange) and the rear partition wall half body 31b (partition wall rear portion) of the bulk head rear portion 3b including the flange F7 (rear flange) to each other. The bulk head 3 with the substantially-H shaped cross section is thereby constructed in which the flanges F6 and F7 extending from the edge portion 33 of the partition wall 31 in both of the vehicle body front and rear directions are formed continuously over the entire periphery 5 of the edge portion 33 of the partition wall 31.

Generally, if the bulk head 3 that is made of a steel material with a substantially-H shaped cross section and that has a complex shape in the present embodiment is manufactured by, for example, hot forging or the like, this manufacturing has problems of complex manufacturing steps and an increase in manufacturing cost.

Meanwhile, each of the bulk head front portion 3a and the bulk head rear portion 3b forming the bulk head 3 in the present embodiment can be obtained more easily at low cost by, for example, press molding of a plate body such as a steel plate. Moreover, the bulk head 3 can be obtained easily at low cost by joining the bulk head front portion 3a and the bulk head rear portion 3b in back-to-back.

Moreover, since the partition wall 31 of the bulk head 3 is formed by connecting the front partition wall half body 31a (partition wall front portion) of the bulk head front portion 3a and the rear partition wall half body 31b (partition wall rear portion) of the bulk head rear portion 3b, the plate thickness of the partition wall 31 can be set greater than the plate thickness of the flange F6 (front flange) and the plate thickness of the flange F7 (rear flange).

In the vehicle body side structure S as described above, the strength of the partition wall 31 against side impact load is further improved unlike in a vehicle body side structure in which the plate thickness of the flanges and the plate thickness of the partition walls are set to be substantially the same as in the conventional vehicle body side structure (for example, see Patent Literature 1).

According to the vehicle body side structure S of the present embodiment, including the bulk head 3 as described above effectively suppresses deformation of the closed cross section shape in the side sill 1 in side impact and causes the side impact load to be efficiently transmitted to the floor cross member 2.

The vehicle body side structure S can more effectively achieve both of the increase in energy efficiency by weight reduction of the vehicle body and the improvement in traffic safety by securing of the stiffness of the vehicle body.

Furthermore, in the vehicle body side structure S, the rear portion of the side sill outer 12 and the front portion of the side sill outer rear member 13 are connected to the bulk head 3 while being made to overlap each other on the vehicle width direction outer side (at the side in the vehicle width direction) of the floor cross member 2.

According to the vehicle body side structure S as described above, since the floor cross member 2 is connected to an installed portion of the bulk head 3 in the side sill 1 that is reinforced by this overlapping, the side impact load is more effectively transmitted to the floor cross member 2.

Moreover, in the vehicle body side structure S, the partition wall 31 of the bulk head 3 is tilted such that a vehicle width direction inner portion of the partition wall 31 is located on the vehicle body front side of a vehicle width direction outer portion of the partition wall 31 in a vehicle body top view.

According to the vehicle body side structure S as described above, the welding gun 8 does not interfere with the partition wall 31 or the flange F6c, F6d, or F6e when the flange F6a of the bulk head 3, the side sill inner 11, and the flange F3 of the floor cross member 2 are spot-welded to one another while being made to overlap one another in three layers. In the vehicle body side structure S, the flange F6 (front flange) can be thereby formed over the entire periphery of the partition wall 31 in the bulk head 3.

Moreover, in the vehicle body side structure S, in the flange F6d (outer flange) extending in the upper-lower direction on the vehicle width direction outer side, the notches N are formed at the positions corresponding to the welding spots W of the flange F6a (inner flange) extending in the upper-lower direction on the vehicle width direction inner side.

According to the vehicle body side structure S as described above, the interference between the welding gun 8 and the flange F6d (outer flange) is more surely avoided when the flange F6a (inner flange), the side sill inner 11, and the flange F3 of the floor cross member 2 are spot-welded to one another while being made to overlap one another in three layers.

Furthermore, according to the vehicle body side structure S as described above, since the interference between the welding gun 8 and the flange F6d (outer flange) is avoided, the length of the flange F6a (inner flange) does not have to be extended forward to set the welding spots W in the flange F6a. Weight reduction of the bulk head 3 is thereby more surely achieved.

Moreover, according to the vehicle body side structure S as described above, since the interference between the welding gun 8 and the flange F6d (outer flange) is avoided, the welding spots W in the flange F6a (inner flange) can be set at positions close to the partition wall 31. The joining strength of the bulk head 3 to the floor cross member 2 is thereby increased, and the side impact load is efficiently transmitted to the floor cross member 2.

The vehicle body side structure S more effectively achieves both of the increase in energy efficiency by weight reduction of the vehicle body and the improvement in traffic safety by securing of the stiffness of the vehicle body.

Furthermore, in the vehicle body side structure S, the notches N are formed to have the depth D that is half or less of the length L2 of the flange F6d (outer flange) from the partition wall 31.

According to the vehicle body side structure S as described above, the notches N of the flange F6d can be prevented from becoming a trigger of deformation of the bulk head 3 in side impact.

Moreover, in the vehicle body side structure S, the bulk head 3 includes the bead 34a that extends in the vehicle width direction on the partition wall 31 and that leads from the flange F7d located on the vehicle width direction outer side to the flange F7a located on the vehicle width direction inner side.

According to the vehicle body side structure S as described above, side impact load is efficiently transmitted to the floor cross member 2 through the bead 34a. The vehicle body side structure S more surely achieves both of the increase in energy efficiency by weight reduction of the vehicle body and the improvement in traffic safety by securing of the stiffness of the vehicle body.

Moreover, in the vehicle body side structure S, the length L1 of the flange F7 (rear flange) is set larger than the length L2 of the flange F6 (front flange) of the bulk head 3 spot-welded to the floor cross member 2.

According to the vehicle body side structure S as described above, the flange F7 (rear flange) can be joined to the side sill inner 11 with the structural adhesive while securing sufficient joining strength without welding. Joining of the side sill inner 11 and the flange F7 (rear flange) with the structural adhesive as described above is particularly effective when the welding gun 8 cannot easily access a joining portion. However, in the vehicle body side structure S of the present embodiment, welding of the flange F7 (rear flange) and the side sill inner 11 is not excluded, and welding may be applied to joining of the flange F7 (rear flange) and the side sill inner 11.

Although the present embodiment has been described above, the present invention is not limited to the aforementioned embodiment, and may be carried out in various modes.

Although the bulk head 3 in the aforementioned embodiment is assumed to be a bulk head formed of a joined body of the bulk head front portion 3a and the bulk head rear portion 3b, the bulk head 3 may be an integrally-molded body.

Although the flanges F6 and F7 of the bulk head 3 in the aforementioned embodiment is assumed to be flanges continuously formed over the entire periphery of the edge portion 33 of the partition wall 31, flanges that are partially discontinuous in the circumferential direction and that are equivalent to those of the present invention are not excluded as long as the object of the present invention is not impaired.

Moreover, although the bulk head 3 in the aforementioned embodiment is tilted such that the plate surface of the partition wall 31 is shifted upward while extending rearward, the bulk head 3 may be configured such that the plate surface is shifted downward while extending rearward.

Furthermore, although the bulk head 3 in the aforementioned embodiment is tilted such that the vehicle width direction inner portion of the bulk head 3 is located on the vehicle body front side of the vehicle width direction outer portion of the bulk head 3 in the vehicle body top view, the bulk head 3 may be configured to be tilted such that the vehicle width direction inner portion is located on the vehicle body rear side of the vehicle width direction outer portion.

In such a configuration, the flange F7a of the flange F7 (rear flange) is arranged to correspond to the floor cross member 2. Moreover, the notches N are desirably formed in the flange F7d.

What is claimed is:

1. A vehicle body side structure comprising:
a side sill that extends in a vehicle body front-rear direction in a vehicle body side portion and that forms a closed cross section;
a floor cross member that is connected to the side sill and that extends in a vehicle width direction; and
a bulk head that partitions the closed cross section of the side sill in the vehicle body front-rear direction, at the side of the floor cross member in the vehicle width direction, wherein
the bulk head includes
a partition wall that partitions the closed cross section in the vehicle body front-rear direction, and
a flange that extends from an edge portion of the partition wall in both of a vehicle body front direction and a vehicle body rear direction and that is formed over an entire periphery of the edge portion of the partition wall, and
the flange is connected to the floor cross member with the side sill in between.

2. The vehicle body side structure according to claim 1, wherein
the bulk head is configured to include
a bulk head front portion formed of a partition wall front portion and a front flange extending forward from the partition wall front portion, and
a bulk head rear portion formed of a partition wall rear portion and a rear flange extending rearward from the partition wall rear portion, and
the partition wall front portion and the partition wall rear portion are connected to each other while being made to overlap each other to form the partition wall of the bulk head.

3. The vehicle body side structure according to claim 1, wherein
the side sill is formed of
a side sill inner,
a side sill outer arranged on the vehicle width direction outer side of the side sill inner, and
a side sill outer rear member arranged behind the side sill outer, and
a rear portion of the side sill outer and a front portion of the side sill outer rear member are connected to the bulk head while being made to overlap each other at the side of the floor cross member in the vehicle width direction.

4. The vehicle body side structure according to claim 1, wherein the partition wall of the bulk head is tilted such that a vehicle width direction inner portion of the partition wall is located on the vehicle body front side of a vehicle width direction outer portion of the partition wall in a vehicle body top view.

5. The vehicle body side structure according to claim 1, wherein, the flange of the bulk head is configured such that
the flange is connected to the floor cross member by spot welding in an inner flange extending in an upper-lower direction on the inner side in the vehicle width direction,
a notch is formed at a position corresponding to a welding spot of the inner flange and the floor cross member in an outer flange extending in the upper-lower direction on the outer side in the vehicle width direction, and
the notch is formed to have a depth that is half or less of a length of the outer flange from the partition wall.

6. The vehicle body side structure according to claim 1, wherein the bulk head includes a bead that extends in the vehicle width direction on the partition wall and that leads from a portion of the flange located on the vehicle width direction outer side to a portion of the flange located on the vehicle width direction inner side.

7. The vehicle body side structure according to claim 2, wherein, in the bulk head,
a length of the rear flange from the partition wall is formed to be larger than a length of the front flange from the partition wall,
the front flange and the side sill are connected to each other by spot welding, and
the rear flange and the side sill are connected to each other with structural adhesive.
